(19) United States
(12) Patent Application Publication
(10) Pub. No.: US 2023/0101296 A1
(43) Pub. Date: Mar. 30, 2023

(54) CLADDING

(71) Applicant: CRP Subsea Limited, Skelmersdale, Lancashire (GB)

(72) Inventor: Austin Harbison, Skelmersdale, Lancashire (GB)

(21) Appl. No.: 17/904,466

(22) PCT Filed: Feb. 17, 2021
(86) PCT No.: PCT/GB2021/050385

§ 371 Date: Aug. 17, 2022

(30) Foreign Application Priority Data
Feb. 17, 2020 (GB) 2002140.8

(51) Int. Cl. F16L 1/12; F16L 3/015; G01D 11/30

(52) U.S. Cl. CPC F16L 1/123; F16L 3/015; G01D 11/30

(57) ABSTRACT

A cladding (10) for an elongate member to be deployed underwater includes multiple cladding sections (12, 26) each being configured to receive the elongate member and each having proximal and distal ends configured to engage with longitudinally neighbouring cladding sections (12, 26) enabling a continuous length of the cladding to be constructed from multiple cladding sections. At least one of the cladding sections is provided with a sensor module dock (28) configured to receive and releasably mount a sensor module (30) to the cladding.

The present invention is concerned with monitoring of elongate underwater members.

The invention is applicable to a range of elongate members deployed underwater including risers, pipelines, hoses, bundled products, cables (e.g. fibre optic or electric cables) umbilicals and so on. But consider the example of risers—tubular structures used in subsea extraction of hydrocarbons such as oil and gas to conduct the hydrocarbons from a wellhead on the seabed to a structure at the surface such as a floating rig. Risers suffer from a variety of factors which affect can cause damage and affect their working lifetime. The consequences of in-service failure of a riser could be severe and the cost of their replacement is large. Without some means of monitoring in-service performance of the riser, operators risk spending large sums replacing infrastructure based on what may be excessively conservative predictions of working lifetime.

Risers and other pipelines and cables can suffer a wide variety of internal and external loads during their working lifetime. One of the primary areas of interest in relation to risers is cumulative fatigue damage, where flexure can be induced by environmental or operational factors such as ocean currents. Another factor is vibration. Underwater members subject to flow (e.g. tidal flow) can suffer vortex induced vibration, in which the shedding of vortices from the downstream side of a member can lead to oscillation which can be amplified due to resonance effects. The product transported by a riser or pipeline may undergo changes that are of operational interest. Examples are changes of product temperature and/or pressure, which might be indicative of problematic formation of waxy deposits in a pipeline requiring intervention. Variations in density of the product conveyed may lead to slug induced vibration, where changes in mass distribution within a conduit initiate oscillatory behaviour.

The need for in-service monitoring is by no means limited to risers. There are numerous other types of elongate member that suffer from variable operational end environmental factors, in which context in-service sensing of such conditions is desirable.

For all of these and other reasons it is desirable to provide for in-service monitoring of factors relating to the performance of elongate underwater members.

Sensor devices for this general purpose are known in the art which comprise an arrangement of sensors and some form of clamp or band to secure the sensor arrangement to the riser. An example is WO2018/185338A1. This discloses a sensor system having a semi-cylindrical portion that seats upon the pipeline and is removably retained upon it using magnets. The device has a temperature sensor and is configured to transmit data through the water using electromagnetic signals. Another example is WO2018/167186A1, which discloses a monitoring system deployed upon a riser and having “nodes” which are attached to the riser through mechanical clamps.

The attachment of clamps and other structures to a riser or pipeline may in itself be burdensome. If it is carried out during deployment, it introduces additional complexity at that stage. If sensor devices are instead mounted on the elongate member subsea, after its deployment, this is likely to involve divers or remotely operated vehicles and is in itself a potentially expensive and troublesome process.

The present inventor has recognised that significant advantages can be obtained by providing for a sensor unit to be carried by ducting carried on the elongate member. Additionally or alternatively the sensor unit may be carried by a VIV suppression device.

Elongate members deployed underwater may be fitted with external ducting for a variety of reasons.

The ducting may serve to protect the member from damage, as for example where the member is deployed on the seabed and might otherwise be subject to abrasion or other physical damage. Cladding may contribute buoyancy to support a part of the weight in water of the elongate member, or it may in other cases provide ballasting for the member.

An example of a protective cladding is provided by GB2260590A. Here, a length of ducting is built up from multiple semi-tubular sections. Each section is banded to and faces toward a similarly formed section to form a full cylinder about the elongate member within. Longitudinally neighbouring sections are coupled together so that a duct of a chosen length can be formed from a chosen number of such sections. The ducting may be straightforwardly attached to the elongate member prior to or during its deployment. Alternatively cladding may be retro-fitted to elongate members already deployed in water.

Cladding may in particular be provided in order to mitigate the effects of a phenomenon known to those skilled in the art as vortex induced vibration (VIV), in which an elongate member exposed to a flow of water may suffer undesirable oscillation due to hydrodynamic effects. It is believed that shedding of vortices from the member on its downstream side can produce lateral forces on the elongate member, and that resonance effects these forces can themselves oscillate in direction. Resonance effects can contribute to the amplitude of the resultant vibration of the elongate member. Damage can be caused.

VIV may be mitigated by provision of some suitable shaped feature on the exterior of the elongate member. This may be provided in the form of a cladding about the elongate member. GB2335248A provides an example where a VIV protection cladding is once more formed from multiple cladding sections which are banded to one another about the elongate member and longitudinally juxtaposed and coupled to form a cladding of a chosen length. The cladding sections carry strakes which together form a helical pattern running along the length of the cladding. In GB2335248A there are three lines of these strakes to provide a formation akin to a triple start screw thread. The strakes may be sufficiently resilient to be deformed during deployment or other handling of the cladding, and to subsequently regain their shape.

Strakes are by no means the only features of shape that are capable of mitigating VIV. For examples of other possible forms of VIV suppression cladding, refer e.g. to WO02095278A, which discloses cladding having fluting or grooves for the purpose, and to GB2385648A, which discloses a VIV mitigation cladding having dimples. Numerous other formations are possible.

A variety of materials and constructional techniques may be used to form claddings for elongate members deployed underwater. Some of the prior art examples referred to above are moulded items. One suitable material is syntactic foam. Another form of construction is taught by GB2419649A. In this example a unitary component extends all the way around the elongate member. It comprises multiple part-cylindrical portions coupled along their axially extending edges through living hinges, so that the cladding section is able to be opened out to receive the elongate member and then closed about it. The cladding disclosed in GB2419649A is manufactured by vacuum forming.

In accordance with a first aspect of the present invention there is a cladding for an elongate member to be deployed underwater, the cladding comprising multiple cladding sections each being configured to receive the elongate member and each having proximal and distal ends configured to engage with longitudinally neighbouring cladding sections enabling a continuous length of the cladding to be constructed from multiple cladding sections, wherein at least one of the cladding sections is provided with a sensor module dock configured to receive and releasably mount a sensor module.

By providing a cladding section with a sensor module dock, the present invention provides for convenient and removable mounting of sensor modules without necessitating any additional complexity or time during deployment of either the cladding or the elongate member itself. A sensor module carried in the dock can be located in a known orientation with respect to the elongate member itself, making it straightforward for example to determine the orientation of the elongate member with respect to the earth's gravitational field or with respect to the earth's magnetic field. The sensor module carried in the dock can be arranged for straightforward retrieval and replacement using a remotely operated vehicle (ROV). Since a given elongate member often carries a cladding at multiple sites (which may be critical sites in terms of performance), or along a major part of its length, the invention can provide numerous sites along the length of the elongate member at which to mount sensor modules.

In a practical case, it is common for a cladding to be applied to an elongate member prior to or during its deployment at sea. In accordance with the present invention, the cladding section provided with the sensor module mounting dock may, in relation to the manner of its deployment, be treated very similarly or identically to any other cladding section, e.g. being simply banded on in sequence.

In accordance with a second aspect of the present invention there is a cladding section for use in a cladding, the cladding section being configured to receive and/or seat upon an elongate member to be deployed underwater and having proximal and distal ends each configured to couple to a neighbouring cladding section, the cladding section comprising a sensor module dock configured to receive and releasably mount a sensor module.

Specific embodiments of the present invention will now be described, by way of example only, with reference to the accompanying drawings, in which:

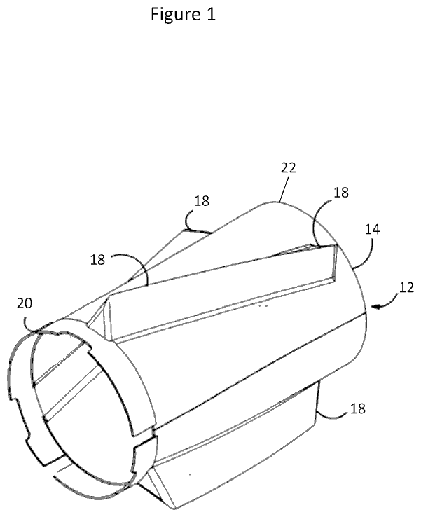

FIG. 1 depicts a cladding section belonging to the prior art, configured as when it is deployed;

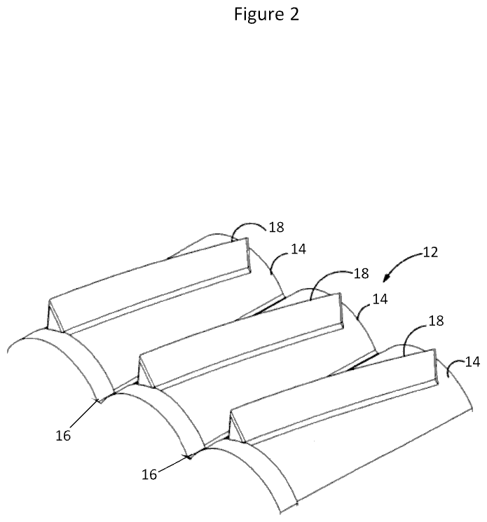

FIG. 2 depicts the same prior art cladding, in this case in an open configuration;

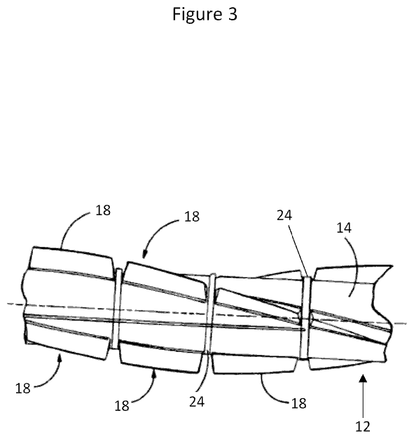

FIG. 3 depicts a prior art cladding formed from the cladding section of FIGS. 1 and 2; and

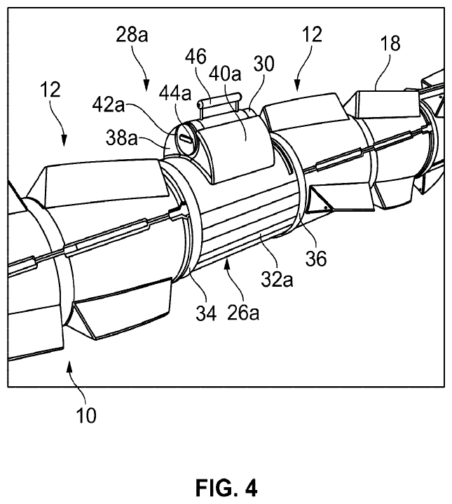

FIGS. 4 to 13 depict respective claddings embodying the present invention, each differing from the other in relation to the formation of a dock for a sensor module.

FIGS. 1 to 3 depict a form of cladding 10 for application to an elongate underwater member. In itself this cladding belongs to the prior art but it is able to be used in implementing the present invention, as will be made clear below. The cladding 10 is presented by way of example and not of limitation—the present invention may be implemented using claddings of different form. The cladding 10 forms a continuous sheath to receive and surround an elongate member. It is constructed from multiple cladding sections 12 which in the present example are unitary components having multiple part-cylindrical sections 14 coupled to one another through longitudinally extending edges through flexible and integral portions 16 which form living hinges. The cladding section 12 is moulded in the configuration depicted in FIG. 2, where part-cylindrical portions 14 are each identically oriented to form a somewhat flat shape. This is convenient in that the entire cladding section 12 is able to be formed in—and more significantly released from—a one-piece mold. This is also a convenient configuration for storage and transportation, since the flat cladding sections 12 can be stacked in a compact manner. Each of the part-cylindrical portions 14 in this example carries a curved strake portion 18. In the present example a cladding section 12 comprises three part-cylindrical portions 14 coupled through two living hinges 16, but this may vary in other embodiments.

By bending the living hinges 16, the cladding section 12 is placed in the closed configuration depicted in FIG. 1, in which the part-cylindrical portions 14 together form a complete cylinder to receive the elongate member (which his not seen in the drawings but may for example have a cylindrical form). In this example the cladding section 12 has a proximal end 20 formed with an enlarged internal diameter and a plain distal end 22, so that the proximal end 20 of one cladding section 12 is able to receive the distal end 22 of another identically formed cladding section 12, enabling longitudinally neighbouring sections to be coupled. Hence a required continuous length of cladding is constructable from a chosen number of cladding sections 12. FIG. 3 shows such a cladding 10, including tension bands 24 which extend around the cladding sections 12 to secure them (a) in the closed configuration, so that they are captive upon the elongate member within and (b) to their longitudinal neighbours. In the assembled cladding 10, the strake portions 18 of neighbouring cladding sections 12 align so that the cladding as a whole has strakes lying on three helical loci, in this particular example.

In accordance with the present invention, the cladding 10 incorporates cladding sections 26 which are able to couple to longitudinally neighbouring cladding sections 12 and which incorporate a sensor module dock 28 to receive and mount a sensor module 30. In some embodiments every cladding section may incorporate a sensor module dock 28. But in the illustrated embodiments the cladding 10 is formed from a mixture of cladding sections 12 lacking a dock and cladding sections 26 having one.

In the embodiment depicted in FIG. 4 the cladding section 26a is seen to have a generally cylindrical body 32a which may be formed in the same manner as the cladding section 12, with multiple part-cylindrical portions coupled through living hinges, and which is configured at proximal and distal ends 34, 36 to engage with neighbouring cladding sections 12. But in accordance with the present invention, the cladding section 26 is provided with sensor module dock 28a which comprises a pair of integral shaped upstands 38a, 40a which together define a part-cylindrical recess receiving the sensor module 30. In this example the sensor module 30 is a push fit in the sensor module dock 28a. The recess defined between the upstands 38a, 40a is open in a radially outward direction. At its radially outer extremity the facing part-cylindrical surfaces 42a, 44a of the upstands 38a, 40a converge somewhat. As the sensor module 30 is pushed into the recess, the upstands are resiliently deformed somewhat, and then snap back into place to embrace and retain the sensor module 30.

The FIG. 4 embodiment takes the form of a VIV mitigation cladding having strakes 18, although in this example the cladding section 26a carrying the sensor module dock 28a lacks strakes.

This and other forms of the sensor module dock 28 and the sensor module 30 are configured to make deployment and retrieval of the sensor module 30 straightforward using an effector of a remotely operated vehicle (ROV). In the FIG. 4 embodiment the sensor module 30 carries a handle 46 which projects radially with respect to the cladding and is easily graspable by an ROV end effector, which can simply push the sensor module 30 into the dock, or pull the sensor module 30 out of the dock.

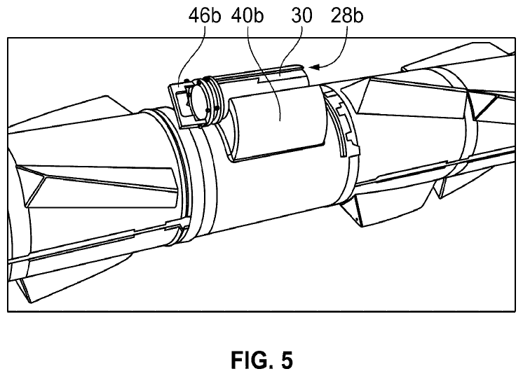

The embodiment depicted in FIG. 5 is similar to that of FIG. 4 in that radial upstands 40b form the sensor module dock 28b, but in this case the sensor module 30 is to be introduced to/withdrawn from the sensor module dock 28b along an axial direction, once more forming a push fit to retain the sensor module 30 in the dock. In this example handle 46b is thus provided on an end of the sensor module 30.

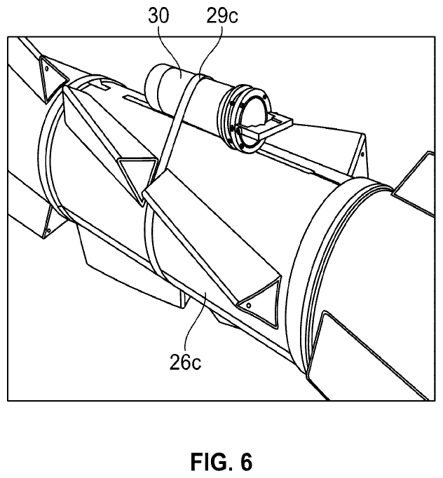

In the embodiment depicted in FIG. 6 the features forming the sensor module dock comprise a suitably shaped outer surface of the cladding and a tension band 29c extending around the sensor module 30 and around the cladding section 26c. The sensor module 30 may be withdrawn axially from this arrangement.

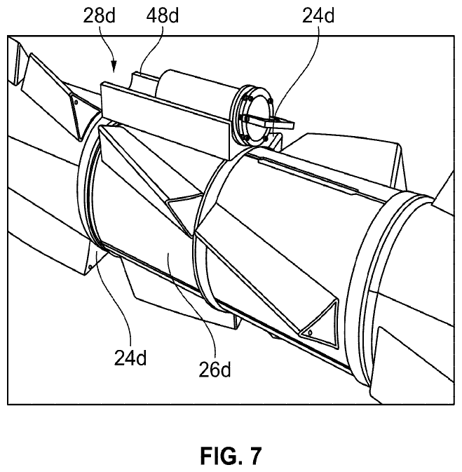

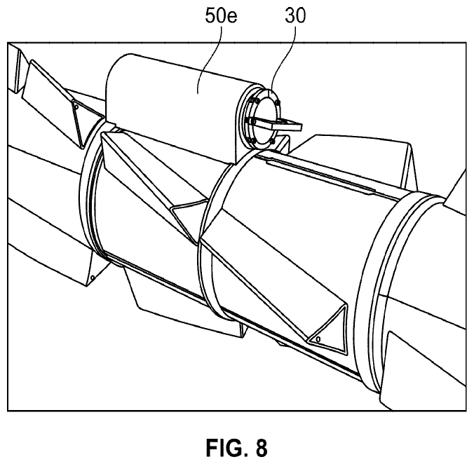

In the embodiment depicted in FIG. 7 the sensor module dock 28d carried by the cladding section 26d comprises a radially outwardly open cradle 48d which is separately formed from the main part of the cladding section 26d but secured to it, e.g. through the tension bands 24d. A suitable releasable clamping or locking arrangement is provided to retain the sensor module 30d in the cradle 48d. FIG. 8 depicts a variant in which the cradle is replaced by a dock body 50e having an internal cavity for receipt of the sensor module 30 with an axially facing opening.

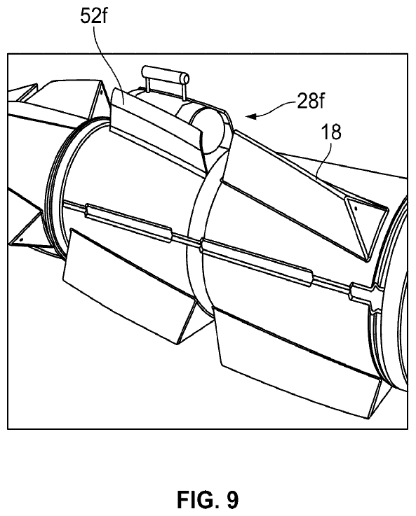

The sensor module dock may be formed by the same features used for mitigation of VIV, or by a variant thereof, and/or it may be aligned with those features. FIG. 9 provides an example in which the sensor module dock 28f is formed by a variant of the strake portion 18 which is split to form two curved leaves 52f to receive and embrace the module. This embodiment may be advantageous hydrodynamically, in that VIV mitigation is not affected by the presence of the dock, but it may also be especially straightforward to mount and deploy e.g. through a stinger, since the continuity of shape of the cladding is little affected by the dock.

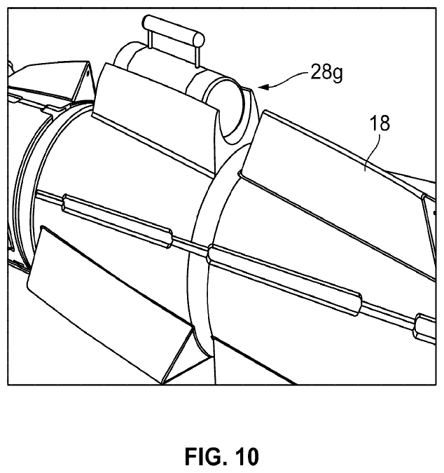

FIG. 10 depicts a variant in which the sensor module dock 28g is again in line with the strakes 18 of the cladding, in this case being formed with a part-circular internal profile into which the sensor module 30 is once more to be snap fitted along a radial direction.

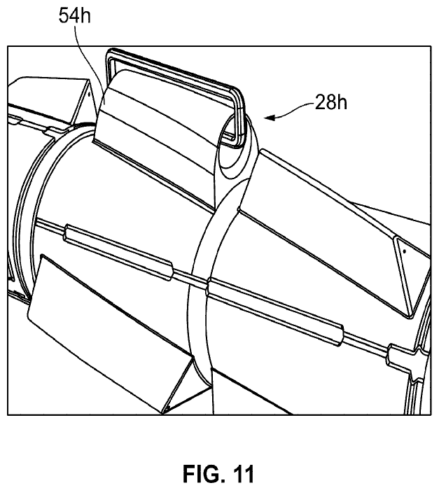

In the FIG. 11 embodiment the sensor module dock 28h comprises a movable part to releasably retain the sensor module 30. This takes the form of a hinged clamp segment 54h.

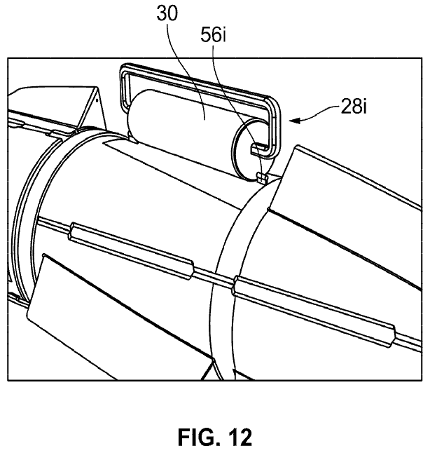

The sensor module dock need not enclose or embrace the sensor module 30 in all embodiments of the invention. FIG. 12 depicts an embodiment of the cladding section 26i in which the sensor module dock 28i comprises a radially upstanding rib 56i for receipt in a complementary channel of the sensor module 30.

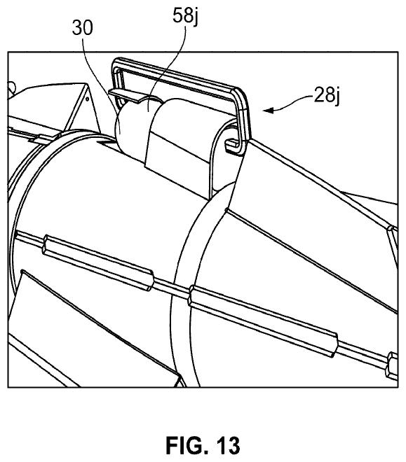

FIG. 13 depicts an embodiment of the invention in which the sensor module 30 is to be twisted to engage and to disengage it to/from the sensor module dock 28j. A shaped channel 58j of the sensor module dock 28j engages a stub or other form of follower (not seen) of the sensor module 30.

Although the sensor module dock may be integrally formed with the cladding section, it need not be so in all embodiments. Another possibility (not depicted) is that the sensor module dock may comprise some form of band or clamp secured around the cladding. For example, the cladding may have a circumferential groove or trough to receive a clamp carrying the sensor module dock. In this way, the sensor module dock is axially located by the cladding, and can be easily and quickly mounted to it during deployment.

The sensor module 30 is, in the illustrated embodiments, a self-contained and self-powered unit able to log sensor data and to output it through a suitable interface. It comprises a sealed pressure vessel seen in FIG. 4 to comprise a cylindrical housing. In the illustrated embodiments the handle 46 is of “D” shape, but it could instead comprise for example a “T” bar or a fishtail configuration, either of which is easily graspable by an end effector of an ROV. Sensors provided in or on the sensor module 30 may comprise any of the following, or any combination of the following:
an accelerometer, which may be a MEMs type device. This may be used to sense acceleration of the elongate member 16 directly, or by integration to determine motion of the elongate member or changes of its position, or to sense its orientation with respect to the earth's gravitational field, or any combination of these all of which can be obtained by processing the accelerometer's output. Accelerometry is for example well suited to detection of slug induced or vortex induced vibration;
a temperature sensor;
a pressure sensor, which can for example be used to determine water depth;
a gyroscope or other sensor responsive to angular movement or angular acceleration;
a magnetometer, especially one which is responsive to the earth's magnetic field to determine orientation.

This list is not exhaustive.

In certain embodiments the sensor module 30 is intended to be retrieved to enable its logged sensor data to be downloaded for analysis. This does not preclude the possibility that some analysis of the data will be carried out on-board the sensor module 30, which may be desirable e.g. for the sake of data compression.

A range of data interfaces may be used to enable transfer of data from the sensor module 30 to some external processing system. In shallow water applications wireless data exchange may be provided. The sensor modules 30 may be connected in the form of a wireless computer network. At greater depths this is not possible. A short range data interface may be provided, which may be optical, radio frequency, acoustic or some other form of short range communication, so that data can be retrieved during a visit by an ROV, submersible or diver without actual retrieval of the sensor module 30. In other embodiments the sensor module 30 is to be periodically retrieved enabling it to be interrogated. It may then be serviced, which will typically include replacement or re-charging of batteries, before being deployed subsea once more.

1. A cladding for an elongate member to be deployed underwater, the cladding comprising multiple cladding sections each being configured to receive the elongate member and each having proximal and distal ends configured to engage with longitudinally neighbouring cladding sections enabling a continuous length of the cladding to be constructed from multiple cladding sections, wherein at least one of the cladding sections is provided with a sensor module dock configured to receive and releasably mount a sensor module.

2. A cladding section for use in a cladding to be carried on an elongate underwater member, the cladding section being configured to receive and/or seat upon the elongate member and having proximal and distal ends each configured to couple to a neighbouring cladding section, the cladding section comprising a sensor module dock configured to receive and releasably mount a sensor module.

3. The cladding as claimed in claim 1, wherein the sensor module dock comprises a recess for receiving the sensor module.

4. The cladding as claimed in claim 1, wherein the cladding comprises a moulding and the sensor module dock is integrally moulded in the cladding.

5. The cladding as claimed claim 1, wherein the sensor module dock is configured to mechanically engage with the sensor module to releasably retain it.

6. The cladding as claimed in claim 1, wherein the cladding has a longitudinal axis and in which the sensor module dock comprises a recess extending substantially axially to receive the sensor module along a substantially axial direction.

7. The cladding as claimed claim 1, wherein the cladding has a longitudinal axis and in which the sensor module dock comprises a recess which is radially open to receive the sensor module along a substantially radial direction.

8. The cladding as claimed claim 1, wherein the sensor module dock is configured to receive the sensor module as a snap fit.

9. The cladding as claimed claim 1, wherein the sensor module dock comprises one or more radial upstands.

10. The cladding as claimed in claim 1, wherein the sensor module dock includes a radially outwardly open channel or recess for receiving the sensor module.

11. The cladding as claimed in claim 1 further comprising a strake, and
wherein the sensor module dock is aligned with the strake.

12. The cladding as claimed in claim 1, wherein the sensor module dock is configured to receive the sensor module in the manner of a part turn lock.

13. The cladding as claimed in claim 1, wherein the sensor module dock comprises an upstanding male feature for receipt in a complementary female feature of the sensor module.

14. A system comprising the cladding as claimed in claim 1 in combination with a sensor module configured to be received by the sensor module dock,
wherein the sensor module comprises a dosed pressure vessel containing at least one sensor, a data logger for logging data from the sensor, an interface for outputting logged sensor data, and a battery arranged to power the sensor and the data logger.

15. The system as claimed in claim 14, wherein the sensor module is retainable frictionally in the sensor module dock.

16. The system as claimed in claim 14, the sensor module is cylindrical and the sensor module dock is complementarily shaped.

17. The system as claimed in claim 14, wherein the sensor module has a handle or other graspable feature to be grasped by an effector of an ROV to facilitate retrieval of the sensor module from the cladding.

18. The cladding section as claimed in claim 2, wherein the sensor module dock includes a recess for receiving the sensor module.

19. The cladding section as claimed in claim 2, wherein the sensor module dock is configured to mechanically engage with the sensor module to releasably retain it.

20. The cladding section as claimed in claim 2, wherein the sensor dock includes one or more radial upstands.
